(19) United States
(12) Patent Application Publication
(10) Pub. No.: US 2018/0047035 A1
(43) Pub. Date: Feb. 15, 2018

(54) ANALYSIS DEVICE, ANALYSIS METHOD, AND COMPUTER-READABLE RECORDING MEDIUM

(71) Applicant: NEC Corporation, Minato-ku, Tokyo (JP)

(72) Inventor: Takashi YOSHIDA, Tokyo (JP)

(73) Assignee: NEC Corporation, Minato-ku, Tokyo (JP)

(21) Appl. No.: 15/550,847

(22) PCT Filed: Mar. 2, 2016
(86) PCT No.: PCT/JP2016/001119

§ 371 Date: Aug. 14, 2017

(30) Foreign Application Priority Data
Mar. 3, 2015 (JP) 2015-040894

(51) Int. Cl. G06Q 30/02

(52) U.S. Cl. CPC G06Q 30/0201

(57) ABSTRACT

Provided is an analysis device and the like that are capable of more accurately deriving similarity between products.

The analysis device includes: first concurrent sales quantity derivation means for deriving a first concurrent sales quantity that is a sales volume of a product purchased concurrently with a first product, first concurrent sales vector derivation means for deriving, based on the first concurrent sales quantity, a first concurrent sales vector representing a relation among a plurality of products purchased concurrently with the first product, second concurrent sales quantity derivation means for deriving a second concurrent sales quantity that is a sales volume of a product purchased concurrently with a second product, second concurrent sales vector derivation means for deriving, based on the second concurrent sales quantity, a second concurrent sales vector representing a relation among a plurality of products purchased concurrently with the second product, and similarity derivation means for deriving, based on the first concurrent sales vector and the second concurrent sales vector, similarity between the first product and the second product.

### TECHNICAL FIELD

The present invention relates to an analysis device, an analysis method, and a computer-readable recording medium.

### BACKGROUND ART

In product planning and sales, prediction relating to an occurrence of brand switch (that a customer who has previously purchased Product A purchases another Product B similar to Product A), and exploration relating to an area where there are fewer similar rival products for differentiation of a new product may be required. When such prediction and the like are performed, a relation of similarity between products is often obtained by quantitatively calculating similarity between combinations of products which belong to a category as an analysis target, by using a certain method.

PTL 1 describes a technique relating to a POS (Point Of Sales) data analysis device and others. The POS data analysis device others described in PTL 1 calculates similarity (a degree of concurrent sales) between products by using concurrent sales characteristic information. In the technique described in PTL 1, examples of the concurrent sales characteristic information include Simpson's coefficient, Jaccard coefficient, and the like. In addition, in the technique described in PTL 1, when vector information is used, Cosine similarity, Pearson's correlation coefficient, and the like are used as the concurrent sales characteristic information.

In addition, NPL 1 describes a method of visualizing POS data. In the method described in NPL 1, a sales status/a concurrent sales status in POS data is visualized by excluding, by using Fisher's exact probability test, concurrent sales information which seems to have no clear intention.

### CITATION LIST

### Patent Literature

[PTL 1] Japanese Unexamined Patent Application Publication No. 2011-258023

### Non Patent Literature

[NPL 1] Takahide HOSHIDE, Ko FUJIMURA, Tatsushi MATSUBAYASHI, “Visualizing Point-of-sales Data using Virtual Topographic Map”, IEICE technical research report, LOIS2009-98, March, 2010

### SUMMARY OF INVENTION

### Technical Problem

In the method described in PTL 1 or NPL 1, similarity between products is obtained based on a degree of concurrent sales (frequency with which a plurality of products are concurrently purchased by a certain customer) of the respective products. However, there is a case where it is difficult to derive similarity between products based on a degree of concurrent sales of the products, depending on products for which similarity is to be obtained.

The present invention has been made in order to solve the problem described above, and a main object of the present invention is to provide an analysis device and others which are capable of more accurately deriving similarity between products.

### Solution to Problem

An analysis device according to an aspect of the present invention includes: first concurrent sales quantity derivation means for deriving a first concurrent sales quantity that is a sales volume of a product purchased concurrently with a first product, first concurrent sales vector derivation means for deriving, based on the first concurrent sales quantity, a first concurrent sales vector representing a relation among a plurality of products purchased concurrently with the first product, second concurrent sales quantity derivation means for deriving a second concurrent sales quantity that is a sales volume of a product purchased concurrently with a second product, second concurrent sales vector derivation means for deriving, based on the second concurrent sales quantity, a second concurrent sales vector representing a relation among a plurality of products purchased concurrently with the second product, and similarity derivation means for deriving, based on the first concurrent sales vector and the second concurrent sales vector, similarity between the first product and the second product.

In addition, an analysis method according to an aspect of the present invention deriving a first concurrent sales quantity that is a sales volume of a product purchased concurrently with a first product;

deriving, based on the first concurrent sales quantity, a first concurrent sales vector representing a relation among a plurality of products purchased concurrently with the first product;

deriving a second concurrent sales quantity that is a sales volume of a product purchased concurrently with a second product;

deriving, based on the second concurrent sales quantity, a second concurrent sales vector representing a relation among a plurality of products purchased concurrently with the second product; and

deriving, based on the first concurrent sales vector and the second concurrent sales vector, similarity between the first product and the second product.

In addition, a computer-readable recording medium according to an aspect of the present invention non-transitorily stores a program that causes a computer to execute processing of deriving a first concurrent sales quantity that is a sales volume of a product purchased concurrently with a first product, deriving, based on the first concurrent sales quantity, a first concurrent sales vector representing a relation among a plurality of products purchased concurrently with the first product, deriving a second concurrent sales quantity that is a sales volume of a product purchased concurrently with a second product, deriving, based on the second concurrent sales quantity, a second concurrent sales vector representing a relation among a plurality of products purchased concurrently with the second product, and deriving, based on the first concurrent sales vector and the second concurrent sales vector, similarity between the first product and the second product.

### Advantageous Effects of Invention

According to the present invention, it is possible to provide an analysis device and others which are capable of more accurately deriving similarity between products.

### BRIEF DESCRIPTION OF DRAWINGS

FIG. 1 is a diagram illustrating a configuration of an analysis device according to a first example embodiment of the present invention;

FIG. 2 is a diagram illustrating an example of sales data used in the analysis device according to the first example embodiment of the present invention;

FIG. 3 is a diagram illustrating an example of a first concurrent sales vector or a second concurrent sales vector used in the analysis device according to the first example embodiment of the present invention;

FIG. 4 is a flowchart illustrating an operation of the analysis device according to the first example embodiment of the present invention;

FIG. 5 is a diagram illustrating a configuration of a modification example of the analysis device according to the first example embodiment of the present invention;

FIG. 6 is a diagram illustrating a configuration of an analysis device according to a second example embodiment of the present invention;

FIG. 7 is a diagram illustrating an example of sales data used in the analysis device according to the second example embodiment of the present invention;

FIG. 8 is a flowchart illustrating an operation of the analysis device according to the second example embodiment of the present invention;

FIG. 9 is a diagram illustrating a configuration of a modification example of the analysis device according to the second example embodiment of the present invention;

FIG. 10 is a diagram illustrating a configuration of an analysis system according to a third example embodiment of the present invention; and

FIG. 11 is a diagram illustrating an example of an information processing device which implements an analysis device and the like according to each of the example embodiments of the present invention.

### DESCRIPTION OF EMBODIMENTS

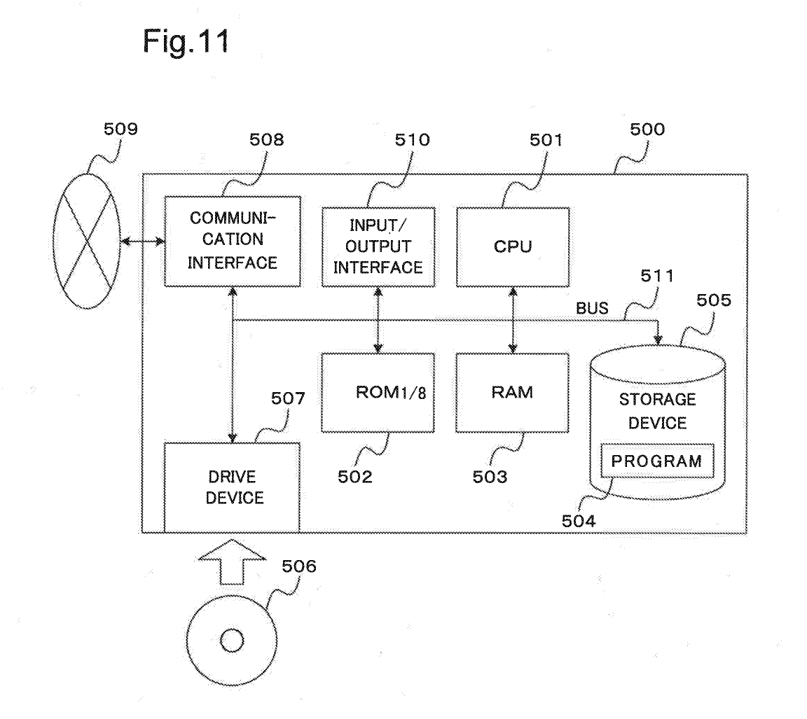

Example embodiments of the present invention will be described with reference to the accompanying drawings. Note that, in each of the example embodiments of the present invention, components in each device indicate blocks on a function basis. Components in each device can be implemented by any combination of, for example, an information processing device 500 as illustrated in FIG. 11 and software. As an example, the information processing device 500 includes configurations as follows.
a CPU (Central Processing Unit) 501
a ROM (Read Only Memory) 502
a RAM (Random Access Memory) 503
a program 504 loaded on the RAM 503
a storage device 505 for storing the program 504
a drive device 507 for reading and writing a recording medium 506
a communication interface 508 connected with a network 509
an input/output interface 510 for inputting and outputting data
a bus 511 connecting the respective components

Components in each device according to each of the example embodiments are implemented by the CPU 501 acquiring and executing the program 504 which implements these functions. The program 504 which implements the functions of the components in each device is stored in advance in, for example, the storage device 505 and the RAM 503, and is read out by the CPU 501 as needed. Note that the program 504 may be supplied to the CPU 501 via the communication network 509, or the program, which is stored in advance in the recording medium 506, may be read out and supplied to the CPU 501 by the drive device 507.

There are various modification examples of a method of implementing each device. For example, each device may be implemented by any combination of the information processing device 500 and a program which are respectively different for each component. In addition, a plurality of components included in each device may be implemented by any combination of one information processing device 500 and a program.

In addition, part or all of components in each device are implemented by a general-purpose or dedicated circuitry, a processor, and the like, or a combination thereof. These may be configured by a single chip, or may be configured by a plurality of chips connected through a bus. Part or all of components in each device may be implemented by a combination of the above-described circuitry or the like and a program.

When part or all of components in each device are implemented by a plurality of information processing devices, circuitries, and the like, the plurality of information processing devices, the circuitries, and the like may be centralizedly arranged, or may be dispersedly arranged. For example, information processing devices, circuitries, and the like may be implemented as a mode, such as a client and server system, and a cloud computing system, in which the information processing devices, the circuitries, and the like are respectively connected via a communication network.

### First Example Embodiment

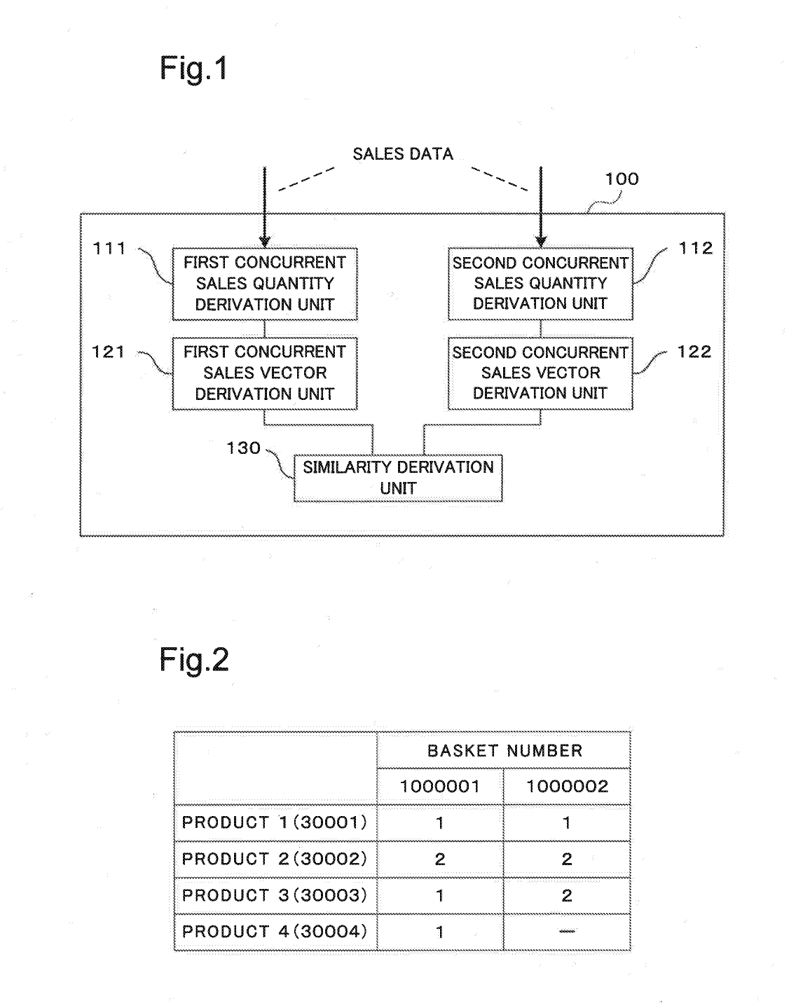

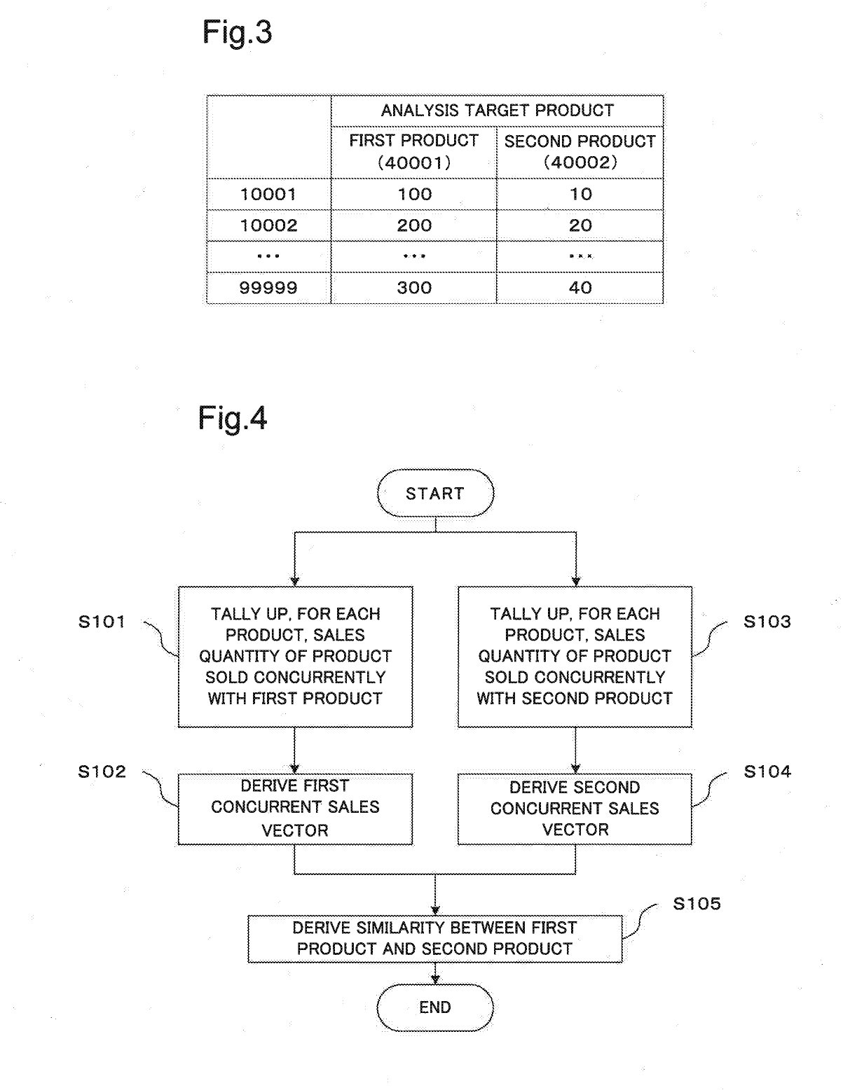

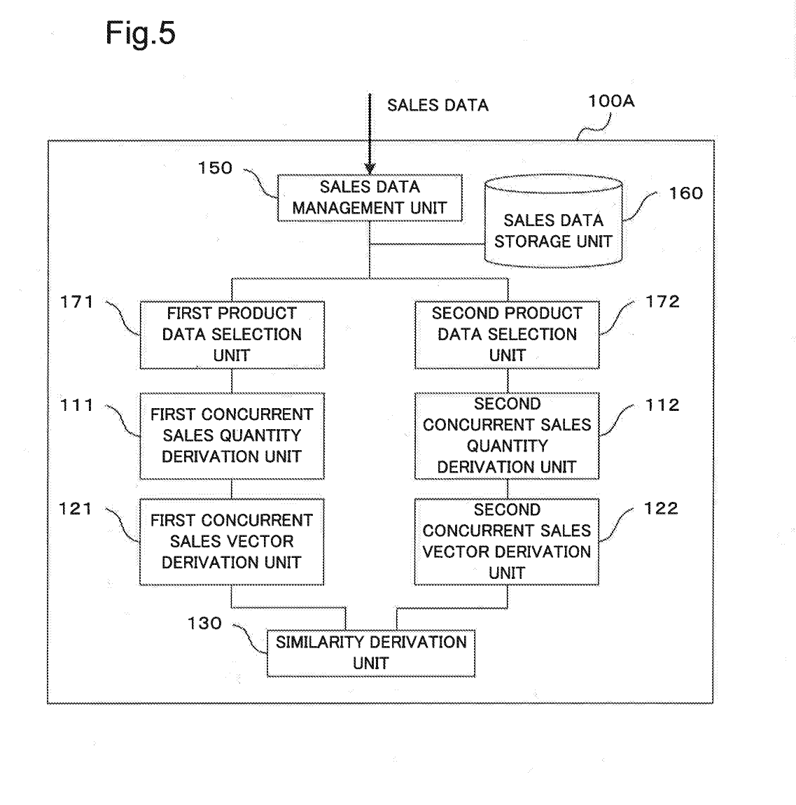

First, a first example embodiment of the present invention will be described. FIG. 1 is a diagram illustrating an analysis device according to the first example embodiment of the present invention. FIG. 2 is a diagram illustrating an example of sales data used in the analysis device according to the first example embodiment of the present invention. FIG. 3 is a diagram illustrating an example of a first concurrent sales vector or a second concurrent sales vector used in the analysis device according to the first example embodiment of the present invention. FIG. 4 is a flowchart illustrating an operation of the analysis device according to the first example embodiment of the present invention. FIG. 5 is a diagram illustrating a configuration of a modification example of the analysis device according to the first example embodiment of the present invention.

As illustrated in FIG. 1, an analysis device 100 according to the first example embodiment of the present invention includes a first concurrent sales quantity derivation unit 111, a first concurrent sales vector derivation unit 121, a second concurrent sales quantity derivation unit 112, a second concurrent sales vector derivation unit 122, and a similarity derivation unit 130.

The first concurrent sales quantity derivation unit 111 derives a first concurrent sales quantity which is a sales volume of a product purchased concurrently with a first product. The first concurrent sales vector derivation unit 121 derives, based on the first concurrent sales quantity, a first concurrent sales vector which represents a relation among a plurality of products purchased concurrently with the first product. The second concurrent sales quantity derivation unit 112 derives a second concurrent sales quantity which is a sales volume of a product purchased concurrently with a second product. The second concurrent sales vector derivation unit 122 derives, based on the second concurrent sales quantity, a second concurrent sales vector which represents a relation among a plurality of products purchased concurrently with the second product. The similarity derivation unit 130 derives, based on the first concurrent sales vector and the second concurrent sales vector, similarity between the first product and the second product.

In the present example embodiment, a first product and a second product are any kinds of two products as targets for derivation of similarity between these products. Note that a product similar to a certain product is, for example, a product which has a function, a feature, and other features in common with the certain product, and which may be possibly released for sale or the like, as an alternative to the product, to a user of the product or others. Similarity between products is a degree obtained by quantifying the above-described similarity relating to at least two products by using any method.

In addition, in the present example embodiment, a sales volume indicates a quantity or a sales amount of a sold product. Hereinafter, in description of each of the example embodiments of the present invention, a sales volume will be described as being a sales quantity. Concurrent sales mean that a plurality of products are concurrently purchased by a certain customer (in other words, a plurality of products are concurrently sold to a certain customer).

Note that, in the present example embodiment, a first concurrent sales quantity and a second concurrent sales quantity may be collectively called as “concurrent sales quantity”. In addition, a first concurrent sales vector and a second concurrent sales vector may be collectively called as a “concurrent sales vector”.

Subsequently, each components of the analysis device 100 according to the present example embodiment will be described.

As described above, the first concurrent sales quantity derivation unit 111 derives a first concurrent sales quantity which is a sales volume of a concurrently purchased product, such as being purchased at the same time with a first product through one transaction. As an example, the first concurrent sales quantity derivation unit 111 derives, for each product, a total sales volume of a product purchased concurrently with a first product as a first concurrent sales quantity, based on sales data representing a purchase (sales) status of a product, etc. including the first product prepared in advance.

Sales data are data obtained by collecting information relating to a product, etc. purchased through one transaction with a customer, etc. A product, etc. purchased through one transaction may be plural in information included in sales data. The first concurrent sales quantity derivation unit 111 derives a first concurrent sales quantity, based on information in which a first product is included in purchased products among the above-described sales data.

FIG. 2 is a diagram illustrating an example of sales data. The example of sales data illustrated in FIG. 2 is based on POS data. In the present example embodiment, a serial number as, for example, a basket number is assigned to each piece of information on the above-described one transaction included in sales data. The example of sales data illustrated in FIG. 2 indicates information relating to transactions with basket number “1000001” and basket number “1000002”. In addition, in FIG. 2, a quantity of products purchased through two transactions represented by the above-described two basket numbers is indicated. In addition, Products 1 to 4 are allocated with product numbers “30001” to “30004”, respectively.

In this example, when it is assumed that a first product is Product 1 and a second product is Product 4, Product 1, which is the first product, is purchased in both pieces of information relating to two transactions included in the sales data. Accordingly, the first concurrent sales quantity derivation unit 111 derives a first concurrent sales quantity, based on the both pieces of information. In other words, the first concurrent sales quantity derivation unit 111 derives a first concurrent sales quantity as 2, 4, 3, and 1 for Product 1, Product 2, Product 3, and Product 4, respectively.

The second concurrent sales quantity derivation unit 112 derives a second concurrent sales quantity which is a sales volume of a product purchased concurrently with a second product. As an example, the second concurrent sales quantity derivation unit 112 may derive a second concurrent sales quantity, based on sales data including a second product prepared in advance, by using the similar method as that of the first concurrent sales quantity derivation unit 111.

In the example of sales data illustrated in FIG. 2 described above, Product 4, which is the second product, is purchased only through a transaction with basket number “1000001”. Accordingly, the second concurrent sales quantity derivation unit 112 derives a second concurrent sales quantity, based on information relating to the transaction with basket number “1000001”. In other words, the second concurrent sales quantity derivation unit 112 derives a second concurrent sales quantity as 1, 2, 1, and 1 for Product 1, Product 2, Product 3, and Product 4, respectively.

The first concurrent sales vector derivation unit 121 derives, based on the first concurrent sales quantity, a first concurrent sales vector which represents a relation among a plurality of products purchased concurrently with the first product. As one example, the first concurrent sales vector derivation unit 121 excludes the first product and the second product, and derives a set representing sales volumes of other products as a first concurrent sales vector. However, the first concurrent sales vector derivation unit 121 may derive a first concurrent sales vector without excluding the first product and the second product.

In the example illustrated in FIG. 2 described above, a first concurrent sales quantity is 2 for Product 2, 4 for Product 3, and 1 for Product 4, respectively, with respect to Product 1 which is the first product. In this case, the first concurrent sales vector derivation unit 121 excludes Product 1 which is the first product and Product 4 which is the second product, and derives a first concurrent sales vector as (4, 3).

In addition, FIG. 3 illustrates an example of a first concurrent sales vector and a second concurrent sales vector with respect to a first product with product number “40001” and a second product with product number “40002”. A table illustrated in FIG. 3 shows that one hundred products with product number “10001”, two hundred products with product number “10002”, and three hundred products with product number “99999” are purchased (sold) concurrently with the first product. In other words, when products purchased concurrently with the first product are the above-described three products, the first concurrent sales vector derivation unit 121 derives as (100, 200, 300).

The second concurrent sales vector derivation unit 122 derives, based on the second concurrent sales quantity, a second concurrent sales vector which represents a relation among a plurality of products purchased concurrently with the second product. The second concurrent sales vector derivation unit 122 may derive second concurrent sales vector by using the similar method as that of the first concurrent sales vector derivation unit 121. As an example, the second concurrent sales vector derivation unit 122 excludes the first product and the second product, and derives a set representing sales volumes of other products as a second concurrent sales vector. The second concurrent sales vector derivation unit 122 may derive a second concurrent sales vector without excluding the first product and the second product.

In addition, the table illustrated in FIG. 3 shows that ten products with product number “10001”, twenty products with product number “10002”, and forty products with product number “99999” are purchased (sold) concurrently with the second product. In other words, when products purchased concurrently with the second product are the above-described three products, the second concurrent sales vector derivation unit 122 derives a first concurrent sales vector as (10, 20, 40).

Note that each of the first concurrent sales vector derivation unit 121 and the second concurrent sales vector derivation unit 122 may derive various aspects of concurrent sales vectors. For example, each of the first concurrent sales vector derivation unit 121 and the second concurrent sales vector derivation unit 122 may obtain a concurrent sales vector regarding all products sold concurrently with the first product or the second product. In addition, each of the first concurrent sales vector derivation unit 121 and the second concurrent sales vector derivation unit 122 may obtain a concurrent sales vector based on a sales volume relating to a product, whose sales quantity satisfies a predetermined condition, among products sold concurrently with the first product or the second product. In this case, each of the first concurrent sales vector derivation unit 121 and the second concurrent sales vector derivation unit 122 obtains, for example, a concurrent sales vector regarding a product, whose sales quantity is not less than a predetermined quantity, among products sold concurrently with the first product or the second product.

In addition, each of the first concurrent sales vector derivation unit 121 and the second concurrent sales vector derivation unit 122 may obtain a concurrent sales vector regarding one or more products that are determined as representative products by any criterion, from among respective products classified in each category. Besides the above, each of the first concurrent sales vector derivation unit 121 and the second concurrent sales vector derivation unit 122 may obtain a concurrent sales vector regarding a product, that is determined as having influence on similarity between the first product and the second product by any method, among products sold concurrently with the first product or the second product.

The similarity derivation unit 130 derives, based on the first concurrent sales vector and the second concurrent sales vector, similarity between the first product and the second product. As an example, the similarity derivation unit 130 derives similarity in such a way as to result in a higher similarity when the first concurrent sales vector and the second concurrent sales vector are close to each other. In other words, the similarity derivation unit 130 derives similarity, based on a concept that the first product is similar to the second product with high possibility when a group of products purchased together with the first product are similar to a group of products purchased together with the second product. In the similarity derivation unit 130, Cosine similarity, Pearson's correlation coefficient, or the like is used as an index of similarity. In addition, in the similarity derivation unit 130, Spearman's rank correlation coefficient, Kendall's rank correlation coefficient, or the like may be used as an index of similarity.

In the example of a concurrent sales vector illustrated in FIG. 3 described above, the similarity derivation unit 130 calculates similarity between the first concurrent sales vector and the second concurrent sales vector as 0.982, by using Pearson's correlation coefficient.

Subsequently, an example of an operation of the analysis device 100 according to the first example embodiment of the present invention will be described by using a flowchart illustrated in FIG. 4.

First, the first concurrent sales quantity derivation unit 111 derives a first concurrent sales quantity (Step S101). Next, the first concurrent sales vector derivation unit 121 derives a first concurrent sales vector, based on the first concurrent sales quantity derived at Step S101 (Step S102).

Along with the operations of Steps S101 and S102, the second concurrent sales quantity derivation unit 112 derives a second concurrent sales quantity (Step S103). In addition, subsequent to the process of Step S103, the first concurrent sales vector derivation unit 121 derives a second concurrent sales vector (Step S104). As an example, the processes of Steps S103 and S104 are respectively performed in the similar way as the processes of Steps S101 and S102.

Note that the flowchart illustrated in FIG. 4 indicates that the operations of Steps S101 and S102 and the operations of Steps S103 and S104 are concurrently performed. However, these operations may be performed in different order from that of the example illustrated in FIG. 4. For example, the processes from Steps S101 to S104 may be executed sequentially in this order.

Finally, the similarity derivation unit 130 derives similarity between a first product and a second product (Step S105). The similarity between the first product and the second product derived by the similarity derivation unit 130 is output from, for example, any output means including a display device, a communication network, or any other means. In addition, the similarity between the first product and the second product derived by the similarity derivation unit 130 may be stored in any kinds of storage means in such a way that it can referred when needed.

As described above, the analysis device 100 according to the first example embodiment of the present invention derives similarity between a first product and a second product, based on concurrent sales vectors relating to a quantity of products sold concurrently with the first product and the second product.

As described in PTL 1, in a technique of determining similarity between two products as being high when the two products are purchased at the same time, there is a case where it is difficult to obtain similarity regarding products or others that are less frequently purchased at the same time. In contrast, the analysis device 100 according to the present example embodiment derives similarity so as to result in a higher similarity relating to two products when products purchased at the same time with the two products are similar to the two products.

In other words, the analysis device 100 according to the present example embodiment is able to derive similarity relating to two products, regardless of frequency with which the two products are purchased at the same time. Therefore, the analysis device 100 according to the present example embodiment is able to derive similarity between products more accurately.

### Modification Example of First Example Embodiment

There are various modification examples conceivable as the analysis device 100 according to the present example embodiment. As a modification example, the analysis device 100 according to the present example embodiment may include a means for acquiring and managing sales data. FIG. 5 illustrates a configuration of an analysis device 100A according to the modification example.

The analysis device 100A illustrated in FIG. 5 further includes, on the analysis device 100 according to the present example embodiment, a sales data management unit 150, a sales data storage unit 160, a first product data selection unit 171, and a second product data selection unit 172.

The sales data management unit 150 receives sales data from outside. As an example, the sales data management unit 150 acquires, as sales data, POS data obtained from a POS terminal or the like disposed in a store, etc., sales result data collected at a time of product selling through an online shop or other shops, and other data via a not-illustrated communication network, etc. In addition, the sales data management unit 150 stores the acquired sales data in, for example, the sales data storage unit 160.

In addition, the sales data storage unit 160 stores sales data relating to a first product and a second product.

The first product data selection unit 171 selects and acquires, from among sales data, information relating to a transaction including a first product. Likewise, the second product data selection unit 172 selects and acquires, from among sales data, sales data relating to a transaction including a second product.

Each of the first product data selection unit 171 and the second product data selection unit 172 reads sales data stored in the sales data storage unit 160 and selects the sales data. Each of the first product data selection unit 171 and the second product data selection unit 172 may acquire sales data directly from the sales data management unit 150 and may select desired information.

Note that, in this modification example, the first concurrent sales quantity derivation unit 111 derives a first concurrent sales quantity, based on sales data relating to a transaction including a first product which are selected by the first product data selection unit 171. Likewise, in this modification example, the second concurrent sales quantity derivation unit 112 derives a second concurrent sales quantity, based on sales data relating to a transaction including a second product which are selected by the second product data selection unit 172. Thus, each of the first concurrent sales quantity derivation unit 111 and the second concurrent sales quantity derivation unit 112 is able to derive a first concurrent sales quantity or a second concurrent sales quantity fast.

The first concurrent sales quantity derivation unit 111 and the second concurrent sales quantity derivation unit 112 may be configured as a single concurrent sales quantity derivation unit. In this case, the concurrent sales quantity derivation unit derives a first concurrent sales quantity or a second concurrent sales quantity as appropriate in accordance with input data. Likewise, the first concurrent sales vector derivation unit 121 and the second concurrent sales vector derivation unit 122 may be configured as a single concurrent sales vector derivation unit.

In addition, the components in the analysis device 100 according to the present example embodiment and the modification example thereof may be implemented as respectively single devices. In this case, as an example, a device which receives a first concurrent sales vector and a second concurrent sales vector obtained by another physically or logically independent device, etc., and which derives similarity between a first product and a second product is implemented as a device for implementing the similarity derivation unit 130. In addition, in this case, devices for implementing the components in the analysis device 100 and the modification example thereof are respectively connected with one another via, for example, a wired or wireless communication network or other means.

Note that, in the present example embodiment, each of the analysis device 100 and the modification example thereof has been described as deriving similarity between products. However, each of the analysis device 100 and the modification example thereof is also possible to derive similarity between other targets. For example, each of the analysis device 100 and the modification example thereof is able to derive similarity between movies or travel destinations. In this case, similarity or other features between movies or travel destinations is derived based on data on favorite movies, travel destinations, etc. which are aggregated for each movie viewer or traveler, instead of data such as the above-described sales data.

### Second Example Embodiment

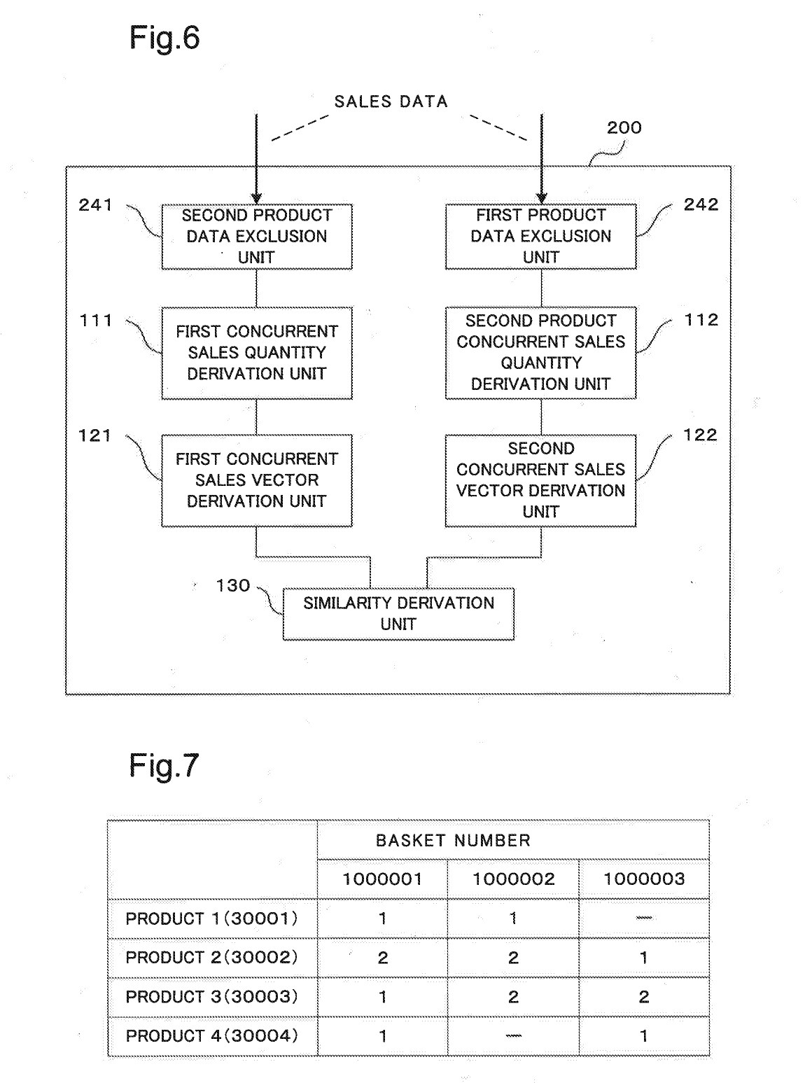

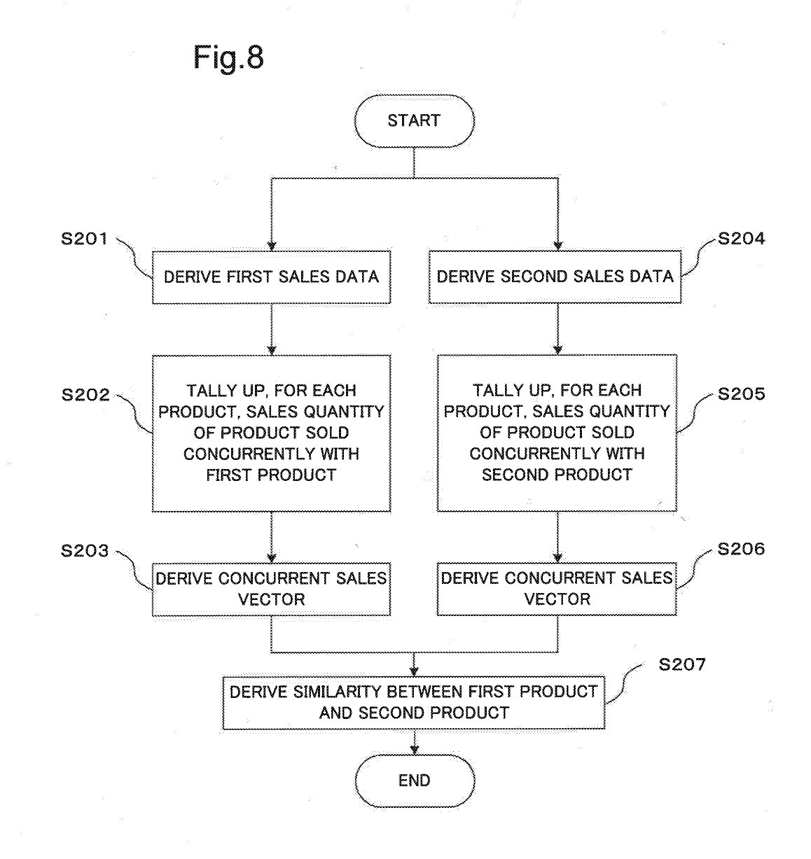

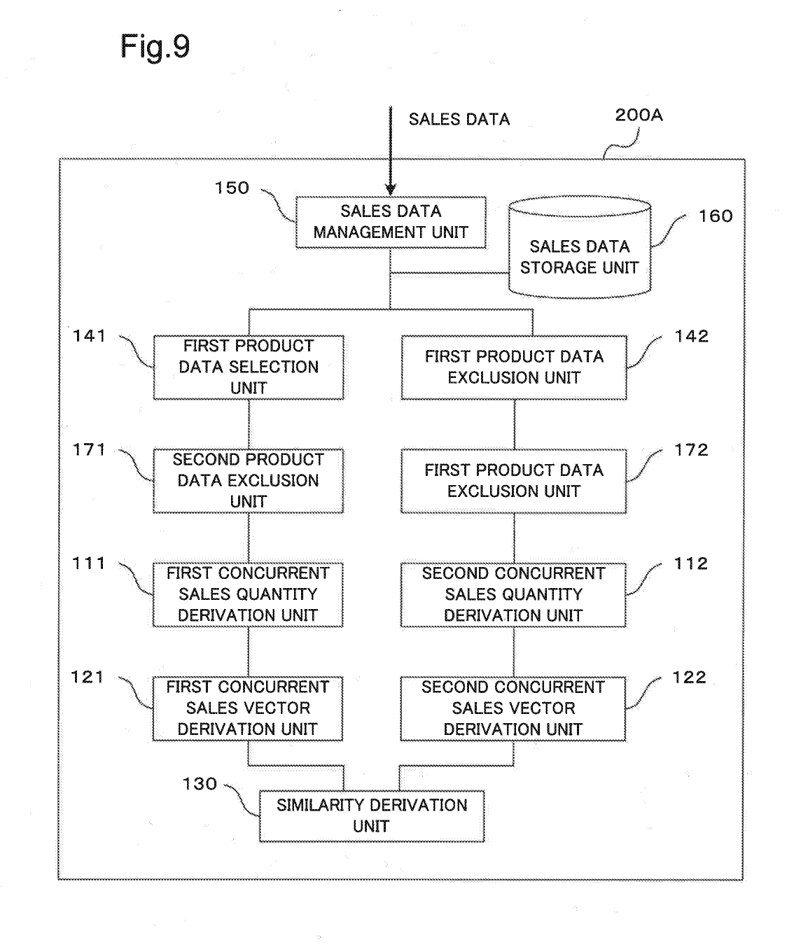

Next, a second example embodiment according to the present invention will be described. FIG. 6 is a diagram illustrating a configuration of an analysis device according to the second example embodiment of the present invention. FIG. 7 is a diagram illustrating an example of sales data used in the analysis device according to the second example embodiment of the present invention. FIG. 8 is a flowchart illustrating an operation of the analysis device according to the second example embodiment of the present invention. FIG. 9 is a diagram illustrating a configuration of a modification example of the analysis device according to the second example embodiment of the present invention.

As illustrated in FIG. 6, an analysis device 200 according to the second example embodiment of the present invention includes a second product data exclusion unit 241, a first product data exclusion unit 242, a first concurrent sales quantity derivation unit 111, a first concurrent sales vector derivation unit 121, a second concurrent sales quantity derivation unit 112, a second concurrent sales vector derivation unit 122, and a similarity derivation unit 130.

The second product data exclusion unit 241 derives first sales data which include information on purchased products (or information on sold products) when the first product and at least one product different from the second product are concurrently purchased by a customer. The first product data exclusion unit 242 derives second sales data which include information on purchased products (or information on sold products) when the second product and at least one product different from the first product are concurrently purchased by a customer. In addition, in the present example embodiment, the first concurrent sales quantity derivation unit 111 derives the first concurrent sales quantity, based on the first sales data derived by the second product data exclusion unit 241. The second concurrent sales quantity derivation unit 112 derives the second concurrent sales quantity, based on the second sales data derived by the first product data exclusion unit 242. Configurations other than the above of the analysis device 200 according to the present example embodiment can be made similarly as those of the analysis device 100 according to the first example embodiment of the present invention.

The second product data exclusion unit 241 derives first sales data, as described above. The first sales data can be considered as being sales data from which information relating to a transaction such that a first product and a second product are concurrently purchased (or sold) is excluded, among sales data relating to the first product. As an example, the second product data exclusion unit 241 derives, from among the above-described sales data, information in which a first product is included in purchased products but a second product is not included therein, as first sales data.

In addition, the first product data exclusion unit 242 derives second sales data similarly as the second product data exclusion unit 241. The second sales data can be considered as being sales data from which information relating to a transaction s a second product and a first product are concurrently purchased (or sold) is excluded, among sales data relating to the second product. As an example, the first product data exclusion unit 242 derives, from among the above-described sales data, information in which a second product is included in purchased products but a first product is not included therein, as second sales data.

In general, products that are frequently purchased concurrently at a time may be dissimilar to each other (in other words, similarity is low). Note that a product that is dissimilar to a certain product is a product which includes a different function and a different feature from the certain product, and which is regarded as having a low similarity.

As an example, sweet bread (for example, sweet buns) and non-sweet bread (for example, stuffed bread) are considered as being dissimilar products, because of different tastes. Sweet bread and non-sweet bread may be purchased at the same time. This can be considered that sweet bread and non-sweet bread are purchased at the same time, since the both have dissimilar tastes and can be eaten continuously without getting tired. In other words, products that are dissimilar to each other may be concurrently purchased because of the dissimilarity. However, it is conceivable that, when information on a case where products that are dissimilar to each other are concurrently purchased is used for deriving similarity between two products, the similarity may not be obtained correctly.

In view of the above, the second product data exclusion unit 241 derives first sales data. The first sales data are sales data from which information relating to a transaction when a first product and a second product, which are targets for deriving similarity, are purchased at the same time is excluded. In addition, the first product data exclusion unit 242 derives second sales data which are similar kind of sales data. By using the first sales data or the second sales data, the analysis device 200 according to the present example embodiment is able to derive similarity between a first product and a second product in consideration that there is a case where products that are dissimilar to each other are concurrently purchased.

An example of first sales data will be described by using an example of sales data illustrated in FIG. 7 described above. The example of sales data illustrated in FIG. 7 is data obtained by further adding information relating to a transaction with basket number “1000003” to the example of sales data illustrated in FIG. 2.

In this example, when it is assumed that a first product is Product 1 and a second product is Product 4, Product 1, which is the first product, is purchased in both pieces of information relating to two transactions with basket numbers “1000001” and “1000002” included in sales data. Meanwhile, in the transaction with basket number “1000001”, Product 4, which is the second product, is purchased. Accordingly, in this example, the second product data exclusion unit 241 derives only information relating to the transaction with basket number “1000002” as first sales data.

In addition, in this case, Product 4, which is the second product, is purchased in both pieces of information relating to two transactions with basket numbers “1000002” and “1000003” included in sales data. Meanwhile, in the transaction with basket number “1000001”, Product 1, which is the first product, is purchased. Accordingly, in this example, the first product data exclusion unit 242 derives only information relating to the transaction with basket number “1000003” as second sales data.

Note that other components included in the analysis device 100 according to the present example embodiment have configurations which operate almost similarly as the corresponding components in the analysis device 100 according to the first example embodiment, except for the above-described contents.

For example, in the example in FIG. 2, the first concurrent sales quantity derivation unit 111 derives a first concurrent sales quantity as 1 for Product 1, 2 for Product 2, and 2 for Product 3, respectively. In addition, in the example in FIG. 7, the first concurrent sales vector derivation unit 121 derives a first concurrent sales vector as (2, 2). The second concurrent sales quantity derivation unit 121 and the second concurrent sales vector 122 operate similarly as the first concurrent sales quantity derivation unit 111 and the first concurrent sales vector 121 respectively. For example, in the example in FIG. 7, the second concurrent sales vector 122 derives a first concurrent sales vector as (1, 2). The similarity derivation unit 130 derives similarity, as with the similarity derivation unit 130 according to the first example embodiment. By using the first sales data and the second sales data described above, the similarity derivation unit 130 is able to accurately derive similarity between products that are dissimilar to each other.

Subsequently, an example of an operation of the analysis device 200 according to the second example embodiment of the present invention will be described by using a flowchart illustrated in FIG. 8.

First, the second product data exclusion unit 241 derives first sales data, based on sales data relating to a first product (Step S201). Subsequently, the first concurrent sales quantity derivation unit 111 derives a first concurrent sales quantity, based on the first sales data derived at Step S201 (Step S202). Next, the first concurrent sales vector derivation unit 121 derives a first concurrent sales vector, based on the first concurrent sales quantity derived at Step S202 (Step S203).

Along with the operations of Steps S201 to S203, the first product data exclusion unit 242 derives second sales data from sales data, based on sales data relating to a second product (Step S204). The second concurrent sales quantity derivation unit 112 derives a second concurrent sales quantity (Step S205). In addition, subsequent to the process of Step S205, the second concurrent sales vector derivation unit 122 derives a second concurrent sales vector (Step S206). As an example, the processes of Steps S204 to S206 are performed similarly as the processes of Step S201 and Step S203 respectively.

Note that the flowchart illustrated in FIG. 8 indicates that the operations of Steps S201 to S203 and the operations of Steps S204 to S206 are concurrently performed. However, these operations may be performed in different order from that in the example illustrated in FIG. 8, similarly to the operation of the analysis device 100 according to the first example embodiment.

Finally, the similarity derivation unit 130 derives similarity between the first product and the second product (Step S207). The similarity between the first product and the second product derived by the similarity derivation unit 130 is output from, for example, any kinds of output means, similarly to the analysis device 100 according to the first example embodiment. In addition, the similarity between the first product and the second product derived by the similarity derivation unit 130 may be stored in any kinds of storage means.

As described above, the analysis device 200 according to the second example embodiment of the present invention derives first sales data and second sales data by using the second product data exclusion unit 241 and the first product data exclusion unit 242, respectively. Then, the analysis device 200 according to the second example embodiment of the present invention derives similarity between a first product and a second product, based on the first sales data and the second sales data.

As described above, products that are frequently purchased concurrently at a time may include products that are dissimilar to each other. The analysis device 200 according to the present example embodiment derives similarity by excluding sales data in which a first product and a second product, which are targets for deriving similarity, are concurrently purchased. In other words, the analysis device 200 according to the example embodiment derives similarity by excluding a case where there is a possibility that two products are concurrently purchased because of the dissimilarity. Therefore, the analysis device 200 according to the present example embodiment is able to derive similarity between products more accurately, in comparison with the analysis device 100 according to the first example embodiment.

### Modification Example of Second Example Embodiment

There are various modification examples conceivable as the analysis device 200 according to the present example embodiment, similarly to the analysis device 100 according to the first example embodiment.

As a modification example, the analysis device 200 according to the present example embodiment may include a means for acquiring and managing sales data, similarly to the modification example of the analysis device 100 according to the first example embodiment. FIG. 9 is a diagram illustrating a configuration of an analysis device 200A according to the modification example.

The analysis device 200A illustrated in FIG. 9 further includes, on the analysis device 200 according to the present example embodiment, a sales data management unit 150, a sales data storage unit 160, a first product data selection unit 171, and a second product data selection unit 172. The respective components are made the same as the corresponding components in the modification example of the analysis device 100 according to the first example embodiment.

The second product data exclusion unit 241 and the first product data exclusion unit 242 may be configured as a single product data exclusion unit. In this case, the product data exclusion unit derives sales data or second sales data as appropriate in accordance with input information.

Besides the above, various configurations indicated as the modification example of the first example embodiment of the present invention can also be applied to the second example embodiment of the present invention as appropriate.

### Third Example Embodiment

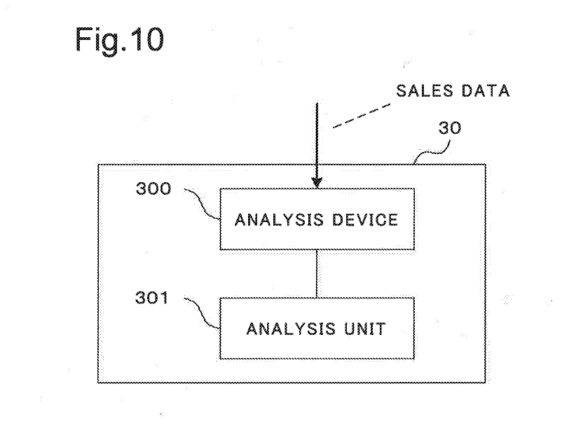

Next, a third example embodiment of the present invention will be described. FIG. 10 is a diagram illustrating a configuration of an analysis system according to the third example embodiment of the present invention.

As illustrated in FIG. 10, an analysis system 30 according to the third example embodiment of the present invention includes an analysis device 300 and an analysis unit 301. The analysis device 300 is the analysis device described in the first example embodiment or the second example embodiment of the present invention, or the various modification examples thereof. The analysis unit 301 derives a similarity relation with respect to a plurality of products, based on similarity derived by the analysis device 300 regarding respective combinations of the plurality of products.

In the present example embodiment, the analysis device 300 derives similarity between two products, which are a first product and a second product, as in the description relating to the first example embodiment or the second example embodiment of the present invention. Meanwhile, in product planning and sales, grasping an overall relation of similarity relating to products which belong to a category as an analysis target may be required.

In the present example embodiment, the analysis unit 301 derives a similarity relation with respect to a plurality of products, by analyzing, for example, a relation of similarity derived by the analysis device 300 regarding between respective combinations of the plurality of products. Since the analysis device 300 is the first example embodiment or the second example embodiment of the present invention, the analysis device 300 derives similarity between two products more accurately. Accordingly, the analysis system 30 according to the present example embodiment is able to derive a more accurate relation of similarity relating to a plurality of products.

The analysis unit 301 visualizes and derives a relation of similarity relating to all of a plurality of products, by using, for example, a method such as cluster analysis, and multidimensional scaling method. In this case, an overall relation of similarity relating to a plurality of products can be grasped quantitatively and visually, based on a result derived by the analysis system 30.

The analysis unit 301 may derive a plurality of similarity relations by analyzing a relation of similarity relating to respective combinations of the plurality of products, by using any method different from the above methods. In the both cases, an overall similarity relation with respect to a plurality of products can be grasped quantitatively, by using a relation of similarity with respect to the plurality of products derived by the analysis system 30 according to the present example embodiment.

Note that a relation of similarity derived by the analysis unit 301 is output from a display device, any kinds of output means including a communication network, etc. In addition, similarity between a first product and a second product derived by the analysis unit 301 may be stored in any kinds of storage means in such that it can be referred when needed.

In addition, a result with respect to a similarity relation derived by the analysis unit 301 is used for various purposes. As an example, the result relating to the similarity relation is applied to, in product planning, a purpose for searching an area where there are fewer similar rival products for differentiation of a new product.

As another example, the result with respect to the similarity relation is used for a use for preventing a situation where stockout of a product leads to loss of sales in a store. In this case, by using the result with respect to the similarity relation, it becomes possible to stock a similar product in a larger amount when there is a conceivable possibility of occurrence of stockout, so as to allow a customer to purchase the similar product even in a case of stockout.

In the above, the invention of the present application has been described with reference to the example embodiments. However, the invention of the present application is not limited to the above-described example embodiments. Various modifications which can be understood by those skilled in the art can be made to the configurations and details of the invention of the present application within the scope of the invention of the present application. In addition, the configurations in the respective example embodiments can be combined with one another within a range not departing from the scope of the present invention.

This application is based upon and claims the benefit of priority from Japanese Patent Application No. 2015-40894, filed on Mar. 3, 2015, the disclosure of which is incorporated herein in its entirety.

### REFERENCE SIGNS LIST

30 Analysis system
100, 100A, 200, 200A, 300 Analysis device
111 First concurrent sales quantity derivation unit
112 Second concurrent sales quantity derivation unit
121 First concurrent sales vector derivation unit
122 Second concurrent sales vector derivation unit
130 Similarity derivation unit
241 Second product data exclusion unit
242 First product data exclusion unit
150 Sales data management unit
160 Sales data storage unit
171 First product data selection unit
172 Second product data selection unit
301 Analysis unit

What is claimed is:

1. An analysis device comprising:
at least one processing component configured to:
derive a first concurrent sales quantity that is a sales volume of a product purchased concurrently with a first product;
derive, based on the first concurrent sales quantity, a first concurrent sales vector representing a relation among a plurality of products purchased concurrently with the first product;
derive a second concurrent sales quantity that is a sales volume of a product purchased concurrently with a second product;
derive, based on the second concurrent sales quantity, a second concurrent sales vector representing a relation among a plurality of products purchased concurrently with the second product; and
derive, based on the first concurrent sales vector and the second concurrent sales vector, similarity between the first product and the second product.

2. The analysis device according to claim 1, wherein
the first concurrent sales vector represents each sales volume of the products purchased concurrently with the first product, and
the second concurrent sales vector represents each sales volume of the products purchased concurrently with the second product.

3. The analysis device according to claim 1, the at least one processing component further configured to:
derive first sales data including information on a purchased product when the first product and at least one product being different from the second product are concurrently purchased;
derive second sales data including information on a purchased product when the second product and at least one product being different from the first product are concurrently purchased;
derive the first concurrent sales quantity based on the first sales data; and
derive the second concurrent sales quantity based on the second sales data.

4. The analysis device according to claim 3, the at least one processing component further configured to:
derive the first concurrent sales vector based on the first concurrent sales quantity derived based on the first sales data, and
derive the second concurrent sales vector based on the second concurrent sales quantity derived based on the second sales data.

5. The analysis device according to claim 1, wherein
the first concurrent sales vector represents each sales volume of the products purchased concurrently with the first product and different from both the first product and the second product, and
the second concurrent sales vector represents each sales volume of the products purchased concurrently with the second product and that are different from both the first product and the second product.

6. The analysis device according to claim 1, the at least one processing component further configured to:
information relating to a transaction including the first product and used when deriving the first concurrent sales quantity; and
information relating to a transaction including the second product and used by when deriving the second concurrent sales quantity.

7. The analysis device according to claim 1, the at least one processing component further configured to:
store sales data including information on a product purchased through a transaction relating to the first product or the second product.

8. An analysis system comprising:
the analysis device according to claim 1; and
an analyzer configured to derive a relation of similarity relating to a plurality of products based on similarity derived by the analysis device.

9. An analysis method comprising:
deriving a first concurrent sales quantity that is a sales volume of a product purchased concurrently with a first product;
deriving, based on the first concurrent sales quantity, a first concurrent sales vector representing a relation among a plurality of products purchased concurrently with the first product;
deriving a second concurrent sales quantity that is a sales volume of a product purchased concurrently with a second product;
deriving, based on the second concurrent sales quantity, a second concurrent sales vector representing a relation among a plurality of products purchased concurrently with the second product; and
deriving, based on the first concurrent sales vector and the second concurrent sales vector, similarity between the first product and the second product.

10. A non-transitory computer-readable recording medium storing a program that causes a computer to execute processing of:
deriving a first concurrent sales quantity that is a sales volume of a product purchased concurrently with a first product;
deriving, based on the first concurrent sales quantity, a first concurrent sales vector representing a relation among a plurality of products purchased concurrently with the first product;
deriving a second concurrent sales quantity that is a sales volume of a product purchased concurrently with a second product;
deriving, based on the second concurrent sales quantity, a second concurrent sales vector representing a relation among a plurality of products purchased concurrently with the second product; and
deriving, based on the first concurrent sales vector and the second concurrent sales vector, similarity between the first product and the second product.
